(19) United States
(12) Patent Application Publication
(10) Pub. No.: US 2026/0040007 A1
(43) Pub. Date: Feb. 5, 2026

(54) AUDIO SEAT AND VEHICLE

(71) Applicant: AAC Acoustic Technologies (Shanghai) Co., Ltd., Shanghai (CN)

(72) Inventors: Huan Ge, Shanghai (CN); Henglizi Zhang, Shanghai (CN); Hongxing Wang, Shanghai (CN); Yuheng Jiang, Shanghai (CN); Lijian Ye, Shanghai (CN)

(21) Appl. No.: 19/002,631

(22) Filed: Dec. 26, 2024

Related U.S. Application Data
(63) Continuation of application No. PCT/CN2024/109905, filed on Aug. 5, 2024.

(51) Int. Cl. H04R 3/14; H04R 1/02; H04R 1/26; H04R 1/40

(52) U.S. Cl. CPC H04R 3/14; H04R 1/025; H04R 1/26; H04R 1/403; H04R 2201/401; H04R 2499/13

(57) ABSTRACT

The present disclosure provides an audio seat and a vehicle. The audio seat includes a seat and at least three micro speaker arrays fixed in the seat at intervals. The seat includes a seat body and a headrest mounted on the top of the seat body. The at least three micro speaker arrays are fixed, close to the headrest, in the seat body or/and fixed in the headrest. When the audio seat is applied to the vehicle, it not only enables relatively concentrated audio playback, but also arrange more micro speaker arrays due to the smaller size of the micro speaker arrays compared to the onboard speaker, thereby greatly improving the effect of audio playback in different areas when applied to vehicles.

### TECHNICAL FIELD

The present disclosure relates to the technical field of audio playback, and in particular to an audio seat and a vehicle.

### BACKGROUND

The technology for controlling the playback of audio content in specific areas within a car is commonly referred to as directional sound or independent audio zone technology, which is an advanced sound field control technology with high consumer demand. The technology can be used for in-car privacy communication, so as to ensure privacy of communication content, or used for partition playback of in-car entertainment audio, allowing passengers in different positions to enjoy different audio content simultaneously, or for some passengers to enjoy entertainment audio while others need to rest or have a phone call without disturbing each other. Of course, the directional sound-emitting or independent sound zone technology can be applied not only to the car, but also to other vehicles, such as the airplane or the train.

The in-car sound field partition control solution in related art is generally implemented by a speaker carried in the vehicle for entertainment audio playback, or by introducing additional onboard speaker arrays. For the mode of realizing the speakers carried in the car, the speaker is distributed at each position in the car to cause relative dispersion. Even with algorithmic compensation, it is difficult to achieve a better audio partition playback effect, and the isolation between each target area is limited. For the mode of introducing an additional onboard speaker array, a large number of onboard speakers cannot be placed in the vehicle due to the large size of the onboard speakers. Furthermore, if the array units are arranged in a regular pattern, the reduced number or irregular distribution of the array units can further degrade the partition playback.

In summary, in the related art, the in-car sound field partition control solutions all have the problem of weak audio partition playback effect.

### SUMMARY

### Technical Problem

The present disclosure aims to provide an audio seat capable of improving the audio partition playback effect of a vehicle.

### Technical Solution

In a first aspect, the present disclosure provides an audio seat applied to a vehicle and including a seat and at least three micro speaker arrays fixed in the seat at intervals.

As an improvement, the seat includes a seat body and a headrest mounted on the top of the seat body. The at least three micro speaker arrays are fixed, close to the headrest, in the seat body or/and fixed in the headrest.

As an improvement, the at least three micro speaker arrays are arranged in a shape of a straight line, a trapezoid, or a triangle.

As an improvement, the at least three micro speaker arrays are fixed in the seat at equal intervals.

As an improvement, at least one micro speaker array of the at least three micro speaker arrays has an open rear cavity structure.

As an improvement, when one micro speaker array of the at least three micro speaker arrays has a closed rear cavity structure, the micro speaker array adopts a first driving signal processed with a full-band algorithm; and when one micro speaker array of the at least one micro speaker array has in an open rear cavity structure, the micro speaker array adopts a second driving signal processed with frequency division, and a middle frequency band and a high frequency band of the second driving signal are processed with a directional control algorithm.

As an improvement, a low frequency band of the second driving signal is processed with a delay correction.

As an improvement, a power rating of each micro speaker array of the at least three micro speaker arrays is smaller than 10 W, and a driving voltage of the micro speaker arrays is smaller than 15V.

As an improvement, the at least three micro speakers comprise eight micro speaker arrays, wherein six micro speaker arrays of the eight micro speaker arrays are sequentially connected and arranged in a straight line of which a middle part is provided with no micro speaker arrays, and another two micro speaker arrays of the eight micro speaker arrays are located at a side of the six micro speaker arrays.

As an improvement, the audio seat is a cinema seat, a game seat, a car seat, or an office seat.

In a second aspect, the present disclosure provides a vehicle including an airplane, a train, or an automobile, the vehicle includes a carrier and a plurality of seats fixed in the carrier, and at least one seat of the plurality of seats is an audio seat. The audio seat includes a seat and at least three micro speaker arrays fixed in the seat at intervals. The seat includes a seat body and a headrest mounted on the top of the seat body. The at least three micro speaker arrays are fixed, close to the headrest, in the seat body or/and fixed in the headrest.

Compared with the related art, the audio seat of the present disclosure is designed with at least three micro speaker arrays in the seat, and the micro speaker arrays are respectively fixed, close to the headrest, in the seat body, or/and fixed in the headrest. Therefore, when the micro speaker arrays are applied to the vehicle, it not only enables relatively concentrated audio playback, but also arrange more micro speaker arrays due to the smaller size of the micro speaker arrays compared to the onboard speaker, thereby improving the effect of audio playback in different areas when applied to vehicles.

### BRIEF DESCRIPTION OF DRAWINGS

In order to describe the technical solutions of the embodiments of the present disclosure more clearly, the following describes the accompanying drawings desired in the embodiments briefly. The accompanying drawings described below are merely some embodiments of the present disclosure, and for those skilled in the art, other accompanying drawings can be obtained based on these accompanying drawings.

FIG. 1 is a first schematic diagram of an audio seat according to Embodiment I of the present disclosure;

FIG. 2 is a second schematic diagram of an audio seat according to Embodiment I of the present disclosure;

FIG. 3 is a third schematic diagram of an audio seat according to Embodiment I of the present disclosure;

FIG. 4 is a fourth schematic diagram of an audio seat according to Embodiment I of the present disclosure;

FIG. 5 is a schematic diagram of two types of micro speaker arrays in an audio seat according to Embodiment I of the present disclosure;

FIG. 6 is an example diagram of a comparison between sound pressure levels of near-field radiation and far-field radiation of micro speaker arrays in which a rear cavity of an audio seat is not in communication with the outside according to Embodiment I of the present disclosure;

FIG. 7 is an example diagram of comparison between sound pressure levels of near-field radiation and far-field radiation of micro speaker arrays with a rear cavity of an audio seat communicating with the outside according to Embodiment I of the present disclosure;

FIG. 8 is a schematic diagram of signal process of an audio seat according to Embodiment I of the present disclosure;

FIG. 9 is an example diagram of an impulse response in the filtering network of the array control algorithm for the audio seat according to Embodiment I of the present disclosure; and

FIG. 10 is a schematic diagram of an automobile according to Embodiment II of the present disclosure.

100—audio seat, 1—seat, 11—seat body, 12—headrest, 2—micro speaker array, 21—rear cavity, 200—car, 201—car body.

### DESCRIPTION OF EMBODIMENTS

The technical solutions in embodiments of the present disclosure will be described clearly and completely below with reference to the drawings in the embodiments of the present disclosure. It should be clear that the described embodiments are only some rather than all of the embodiments of the present disclosure. Based on the embodiments the present disclosure, all other embodiments obtained by those skilled in the art fall within the protection scope of the present disclosure.

### Embodiment I

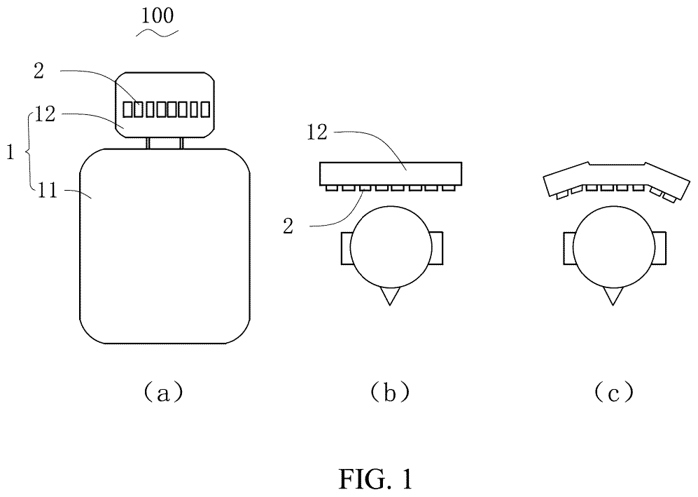

The present disclosure provides an audio seat 100, as shown in FIG. 1 to FIG. 4, including a seat 1 and at least three micro speaker arrays 2 fixed in the seat 1 at intervals.

The audio seat 100 is applied to a vehicle, and is configured as a seat of the vehicle, such as an airplane, a train, an automobile, and so on. According to actual requirements, the audio seat 100 can also be configured as a cinema seat, a game seat, an office seat, and so on.

A power rating of the micro speaker arrays 2 is smaller than 10 W, and a driving voltage of the micro speaker arrays 2 is smaller than 15V.

The micro speaker arrays 2 are sequentially connected to form a shape of a straight line, a trapezoid, or a triangle. According to actual requirements, at least three micro speaker arrays 2 can also be arranged in other shapes or irregularly arranged after being sequentially connected.

The micro speaker arrays 2 are fixed in the seat 1 at equal intervals. According to actual needs, the micro speaker arrays 2 can also be fixed in the seat 1 at unequal intervals.

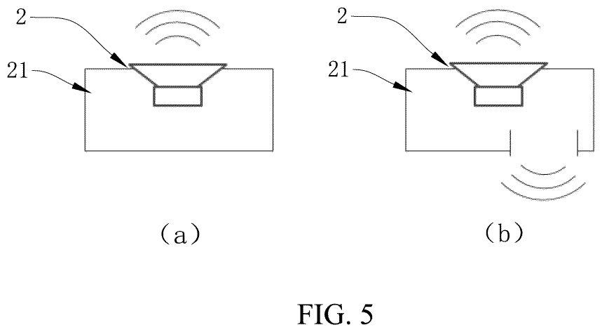

FIG. 5 is a schematic diagram of two types of micro speaker arrays 2, where (a) is a structure of micro speaker arrays 2 in which the rear cavity 21 does not communicate with the outside, and (b) is a structure of micro speaker arrays 2 in which the rear cavity 21 communicates with the outside.

The rear cavity 21 of the one or more micro speaker arrays 2 communicates with the outside. Such design can export the sound radiated backwards by the vibration units of the micro speaker arrays 2 through reasonable pipeline design. Based on the characteristics of sound waves, combined with reasonable pipeline design, audio export method, and direction design, far-field radiation audio cancellation in the middle frequency band and the low frequency band can be achieved to maintain good radiation effect in the near-field, thereby improving the audio pointing effect in the middle frequency band and the low frequency band to a certain extent. Combined with directional control algorithms for driving signals, higher performance directional control functions can also be achieved. The sound radiated backwards by the vibration unit of the micro speaker arrays 2 that is not connected to the outside in the rear cavity 21 will be blocked inside the cavity, which will not affect the sound waves radiated forwards and can prevent sound short circuits, to improve the output capability.

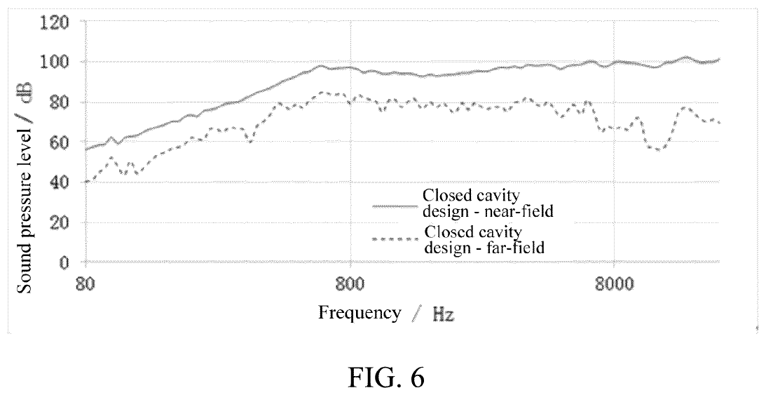

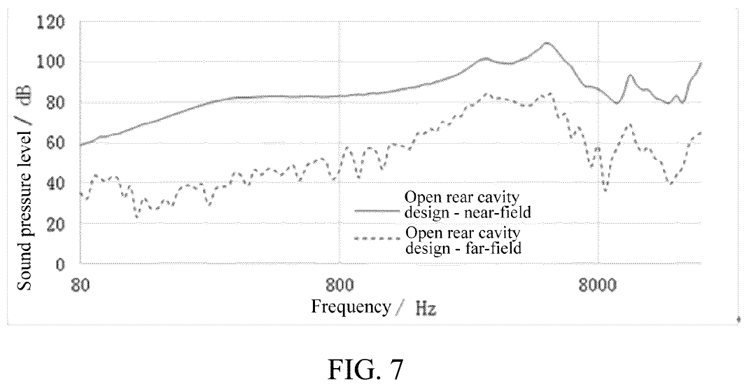

With reference to FIG. 6 and FIG. 7, the micro speaker arrays 2 with a rear cavity 21 structure not in communication with the outside, are referred to as a micro speaker arrays 2 with a closed rear cavity 21 structure, and also referred to as an open rear cavity design. A response difference between a near field and a far field is mainly due to attenuation caused by different distances. The micro speaker arrays 2 with a rear cavity 21 structure in communication with the outside, is referred to as a micro speaker arrays 2 with an open rear cavity 21 structure, and also referred to as a closed rear cavity design. Due to a special structural design, there are additional differences introduced by the acoustic structure in addition to the differences caused by distance attenuation in the response of near-field and far-field. For the middle and low frequency bands, the introduction of the open rear cavity 21 can bring about a sound pressure level difference of over 25 dB between near-field and far-field radiation, thereby significantly improving the directionality of sound radiation. Therefore, the introduction of the micro speaker arrays 2 with the open rear cavity 21 can enhance the directional characteristics of the audio seat 100.

In the micro speaker arrays 2, the micro speaker array 2 with rear cavity 21 not in communication with the outside, adopts a first driving signal processed by a full-band algorithm. The micro speaker array 2 with rear cavity 21 in communication with the outside adopts a second driving signal processed by frequency division. A middle frequency band and a high frequency band of the driving signal are processed by a directional control algorithm, and a middle frequency band and a low frequency band of the driving signal are processed by delay correction.

The seat 1 includes a seat body 11 and a headrest 12 mounted on the top of the seat body 11. At least three micro speaker arrays 2 are fixed, close to the headrest 12, in the seat body 11 or/and fixed in the headrest 12.

In order to better understand various arrangements of the micro speaker arrays 2 and the beneficial effects it brings, eight micro speaker arrays 2 are arranged as examples below.

FIG. 1 is a first arrangement of the micro speaker arrays 2. (a) is a front view of the audio seat 100, (b) is atop view of the flat headrest 12, (c) is a top view of the headrest 12 semi-surrounded on both sides. As can be seen in FIG. 1, eight micro speaker arrays 2 are all arranged on the headrest 12 and are linearly arranged after being sequentially connected, and the other eight micro speaker arrays 2 are arranged at equal intervals.

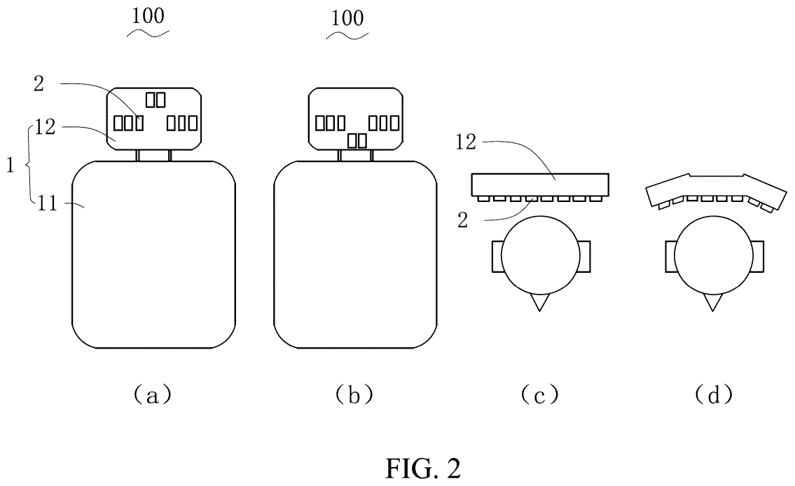

FIG. 2 is a second arrangement of the micro speaker arrays 2. (a) is a front view of the first arrangement of eight micro speaker arrays 2 in the audio seat 100, (b) is a front view of a second arrangement of eight micro speaker arrays 2 in the audio seat 100, (c) is a top view of a flat headrest 12 of the first arrangement and the second arrangement of the eight micro speaker arrays 2, and (d) is a top view of a headrest 12 semi-surrounded on two sides in the first arrangement and the second arrangement of the eight micro speaker arrays 2. As can be seen in FIG. 2, six micro speaker arrays 2 are sequentially connected and arranged in a straight line of which a middle part is provided with no micro speaker arrays 2 in the middle. Another two micro speaker arrays 2 are located at a side of the six micro speaker arrays 2, and are also correspondingly set in the middle of the six micro speaker arrays 2 connected in sequence. At the same time, all eight micro speaker arrays 2 are arranged in the headrest 12. Such design can avoid the occupant's head obstructing the sound-emitting of the micro speaker arrays 2, thereby enhancing the sound effect of the micro speaker arrays 2.

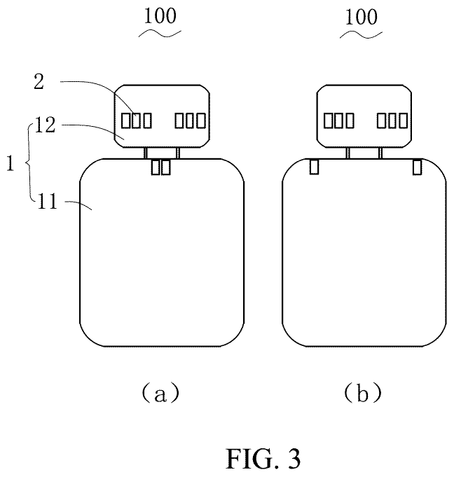

FIG. 3 is a third arrangement of the micro speaker arrays 2. (a) is a front view of the first arrangement of eight micro speaker arrays 2 in the audio seat 100, (b) is a front view of a second arrangement of eight micro speaker arrays 2 in the audio seat 100. As can be seen in FIG. 2, six micro speaker arrays 2 are sequentially connected and arranged in a straight line of which a middle part is provided with no micro speaker arrays 2. Six micro speaker arrays 2 are all installed in the headrest 12, while the other two micro speaker arrays 2 are installed in the seat body 11, which can be correspondingly installed in the middle part after the six micro speaker arrays 2 are sequentially connected, or at the two ends after the six micro speaker arrays 2 are sequentially connected. Such design can also avoid the occupant's head obstructing the sound output of the micro speaker arrays 2, thereby improving the sound effect of the micro speaker arrays 2.

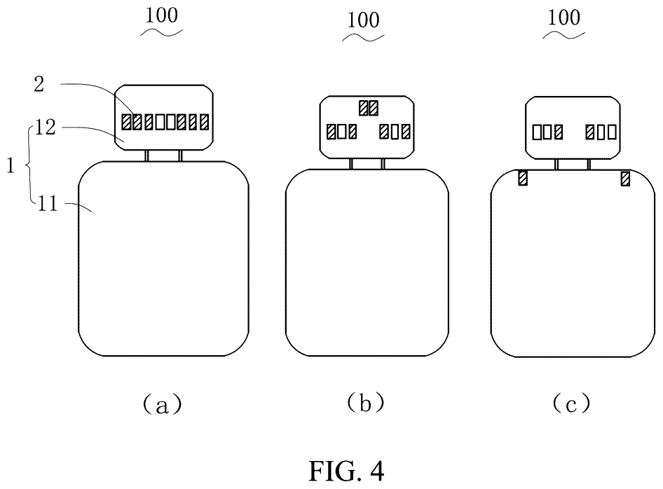

FIG. 4 is a fourth arrangement of the micro speaker arrays 2, (a) adopts the first arrangement of the micro speaker arrays 2, (b) adopts the second arrangement of the micro speaker arrays, and (c) adopts the arrangement of FIG. 3 (b). The difference is that micro speaker arrays 2 in each of the first arrangement, the second arrangement, and the third arrangement adopts micro speaker arrays 2 with the rear cavity 21 not connected to the outside, while the fourth type of micro speaker arrays 2 uses the micro speaker arrays 2, which includes the micro speaker arrays 2 with the rear cavity 21 not connected to the outside and the micro speaker arrays 2 with the rear cavity 21 connected to the outside. The micro speaker arrays 2 with the rear cavity 21 not connected to the outside are directly represented by boxes, while the micro speaker arrays 2 with the rear cavity 21 connected to the outside are represented by a striped box. Such mixed arrangement includes not only the arrangement in FIG. 4, but also other mixed arrangements according to actual needs.

The arrangement of the above four micro speaker arrays 2 is merely taken as an example, and other arrangements thereof can be provided according to actual needs.

The array directional control algorithm in the related art is based on the test of the performance of the speakers and the acoustic environment of the array application. By processing the audio signals provided to each array unit speaker, it is possible to direct the array towards a predetermined target sound-emitting area and suppress the radiation of audio towards the predetermined target suppression area, thereby achieving the target of directional or regional sound-emitting.

According to the audio seat 100 provided in this embodiment, an array directional control algorithm can be introduced based on the micro speaker arrays 2 of the open rear cavity 21 and different forms of arrangement designs, to further improve a directional sound-emitting effect. Compared with the micro speaker arrays 2 with closed rear cavity 21, the micro speaker arrays 2 with open rear cavity 21 have improved directional sound-emitting performance, which is mainly concentrated in the middle and low frequency bands.

The array directional control algorithm in the related art usually adopts a filtering network to filter each input signal to each speaker driving channel. The parameters of the filtering network are jointly determined by the response characteristics of each speaker, the in-vehicle environment in which the speaker is located, the target sound-emitting area, the sound suppression area and the like. For onboard applications, no matter whether the in-vehicle speaker is directly adopted or an additional speaker array is adopted for directional control, the number of output channels will be relatively large, such as 6 channels or more, and each output channel needs to introduce independent filtering processing. For the multi-channel audio playback, an additional number of filtering processes equal to the number of output channels needs to be additionally increased every time one input audio channel is added. Therefore, in an onboard application, implementing directional algorithm control or independent sound zone playback with a better effect requires a large amount of processor computing resources.

Correspondingly, for the array directional control algorithm, as an additional signal processing module added between the input signal and the output signal of the speaker, the array directional control algorithm can be configured as an independent system. The impulse response of the system directly determines the advantages and disadvantages of the directional control algorithm and the required computational load. When the control algorithm needs to perform relatively accurate modeling and restoration on the low frequency band, the order requirement required by the impulse response of the control system is very high, which will greatly increase the computational load.

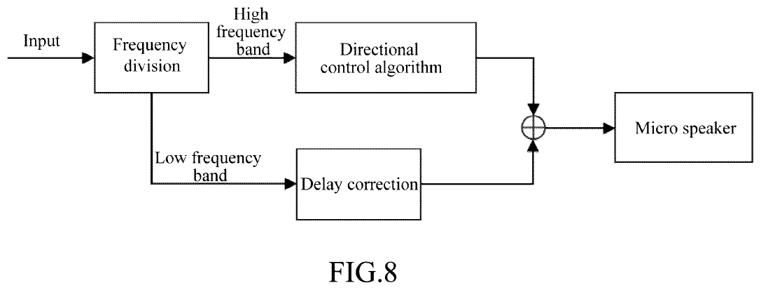

With reference to FIG. 8, in the audio seat 100 of the present embodiment, by introducing the micro speaker arrays 2 of the open rear cavity 21 and combining the micro speaker arrays 2 with the array directional control algorithm, for the input audio signal, after the two-channel frequency division processing, the signal in the high frequency band is processed by the directional algorithm, and the signal in the low frequency band is not processed by the directional algorithm, but after some delay correction, is mixed with the middle frequency band signal and high frequency band signal that are processed by the directional algorithm, and then drives the micro speaker arrays 2 of the open rear cavity 21. That is, the micro speaker arrays 2 with open rear cavity 21 no longer needs to process signals in the middle and low frequency bands, so the filter length adopted by the algorithm can be greatly reduced.

In this embodiment, the middle frequency band signal and the high frequency band signal of the audio seat 100 are processed by using the array directional control algorithm to improve the directional of the corresponding frequency band of the micro speaker arrays 2. However, the middle frequency band signal and the low frequency band signal do not need additional directional enhancement algorithm, and can achieve directional effect of the middle and low frequency bands only by using the structural design characteristics of the open rear cavity 21. The two are combined to achieve the directional control of the full frequency band. The selection of frequency division points for frequency division processing needs to be based on the structural design and performance characteristics of the micro speaker arrays 2 with an open rear cavity 21.

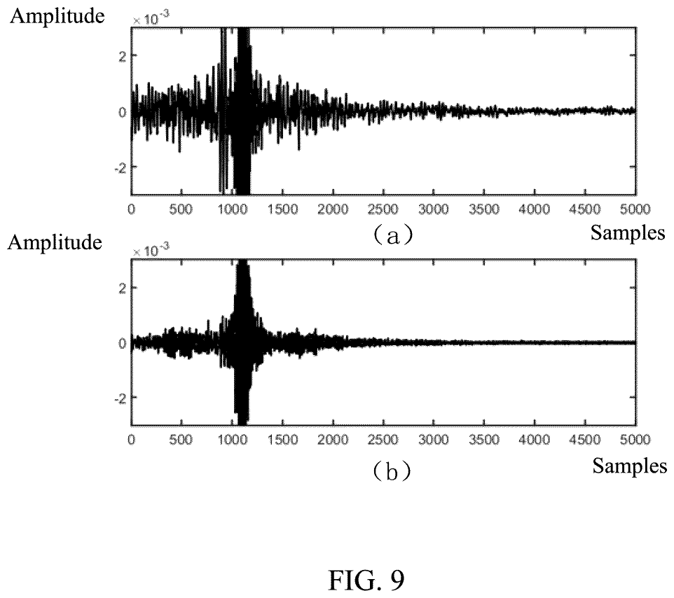

FIG. 9 is an example diagram of an impulse response in the filtering network of the array control algorithm, where (a) is an example diagram of the impulse response of a filter required for processing a full-band signal, and (b) is an example diagram of the impulse response of a filter required for only a middle band signal and a high band signal that are processed with a high-pass filtering. It can be seen from FIG. 9 that the impulse response of the filter that directly processes the full-band signal has a relatively obvious low-frequency tail. Even if a 5000-point long impulse response is used, the amplitude of the whole impulse response cannot be attenuated to be small level enough. However, when processing only the middle and high frequencies, the amplitude of the impulse response is attenuated to a sufficiently small level after about 3000 points. That is, when processing only the middle and high frequencies, the number of points required by the directional control filter can be reduced by about half, which can significantly reduce the computational load required for filtering processing.

Compared with the related art, the audio seat 100 of the present embodiment is designed with at least three micro speaker arrays 2 in the seat 1, and the micro speaker arrays 2 are respectively fixed, close to the headrest 12, in the seat body 11 or/and fixed in the headrest 12. Therefore, when the micro speaker arrays are applied to the vehicle, it not only enables relatively concentrated audio playback, but also arrange more micro speaker arrays due to the smaller size of the micro speaker arrays compared to the onboard speaker, thereby greatly improving the effect of audio playback in different areas when applied to vehicles.

### Embodiment II

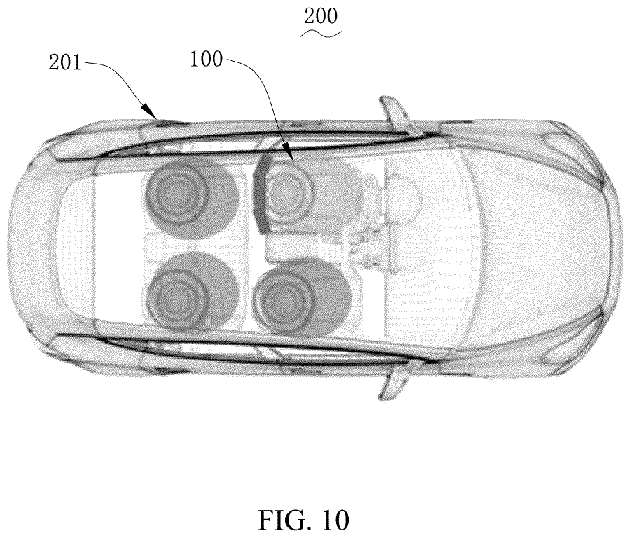

A car 200, as shown in FIG. 10, includes a car body 201 and four seats fixed in the car body 201.

The driver's seat adopts the audio seat 100 as described in the foregoing embodiments. According to time requirements, one or more other seats can also be designed as the audio seat 100 in the foregoing embodiments.

Since the car 200 in this embodiment adopts the audio seat 100 in the foregoing embodiments, it can also achieve the technical effect achieved by the audio seat 100 in the foregoing embodiments, which are not described herein again.

The foregoing description merely illustrates some embodiments of the present disclosure, and it should be noted that those skilled in the art can also make improvements without departing from a concept of the present disclosure, but these all improvements shall fall into a protection scope of the present disclosure.

What is claimed is:

1. An audio seat, comprising:
a seat, wherein the seat comprises a seat body and a headrest mounted on top of the seat body; and
at least three micro speaker arrays fixed in the seat at intervals, wherein the at least three micro speaker arrays are fixed, close to the headrest, in the seat body or/and fixed in the headrest.

2. The audio seat as described in claim 1, wherein the at least three micro speaker arrays are arranged in a shape of a straight line, a trapezoid, or a triangle.

3. The audio seat as described in claim 1, wherein the at least three micro speaker arrays are fixed in the seat at equal intervals.

4. The audio seat as described in claim 1, wherein at least one micro speaker array of the at least three micro speaker arrays has an open rear cavity structure.

5. The audio seat as described in claim 4, wherein when one micro speaker array of the at least three micro speaker arrays has a closed rear cavity structure, the micro speaker array adopts a first driving signal processed with a full-band algorithm; and when one micro speaker array of the at least one micro speaker array has in an open rear cavity structure, the micro speaker array adopts a second driving signal processed with frequency division, and a middle frequency band and a high frequency band of the second driving signal are processed with a directional control algorithm.

6. The audio seat as described in claim 5, wherein a low frequency band of the second driving signal is processed with a delay correction.

7. The audio seat as described in claim 1, wherein a power rating of each micro speaker array of the at least three micro speaker arrays is smaller than 10 W, and a driving voltage of the micro speaker arrays is smaller than 15V.

8. The audio seat as described in claim 1, wherein the at least three micro speakers comprise eight micro speaker arrays, wherein six micro speaker arrays of the eight micro speaker arrays are sequentially connected and arranged in a straight line of which a middle part is provided with no micro speaker arrays, and another two micro speaker arrays of the eight micro speaker arrays are located at a side of the six micro speaker arrays.

9. The audio seat as described in claim 1, wherein the audio seat is a cinema seat, a game seat, a car seat, or an office seat.

10. A vehicle, comprising an airplane, a train, or an automobile, wherein the vehicle comprises a carrier and seats fixed in the carrier, and at least one seat of the seats is an audio seat, the audio seat comprises a seat and at least three micro speaker arrays fixed in the seat at intervals, wherein the seat comprises a seat body and a headrest mounted on top of the seat body, and the at least three micro speaker arrays are fixed, close to the headrest, in the seat body or/and fixed in the headrest.
